(19) United States
(12) Patent Application Publication
(10) Pub. No.: US 2009/0262673 A1
(43) Pub. Date: Oct. 22, 2009

(54) AUTOMATED MODE CHANGE FOR WIRELESS DEVICES DURING INACTIVITY

(75) Inventor: Marion HERMERSDORF, Helsinki (FI)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/106,731

(22) Filed: Apr. 21, 2008

(51) Int. Cl. H04B 7/00

(52) U.S. Cl. 370/310

(57) ABSTRACT

Embodiments enable using the inactive time when a mobile device is not moving to change its mode to a new state or condition of performing as if it were an access point. The embodiments can include determining if a wireless device is stationary, changing an operating mode of the wireless device from mobile mode to access point mode, and determining a current location for the wireless device with respect to a plurality of wireless access point devices. Thereafter, the embodiments can include providing stationary location services with the wireless device to other mobile wireless devices. Later, the embodiments can include detecting that the wireless device is no longer stationary; and changing the operating mode of the wireless device from access point mode to mobile mode.

### FIELD

The embodiments relate to using the inactive time when a mobile device is not moving to assist others by changing its mode to a new state or condition of performing as if it were an access point.

### BACKGROUND

A wireless access point is a network device that interconnects mobile wireless devices in a wireless radio network to a wired network infrastructure. Whether the wireless network is a wireless personal area network (WPAN) operating, for example, under the Bluetooth or IEEE 802.15 network protocol, a wireless local area network (WLAN) operating, for example under the IEEE 802.11, Hiperlan, WiMedia Ultra Wide Band (UWB), WiMax, WiFi, or Digital Enhanced Cordless Telecommunications (DECT) network protocol, or a wireless wide area network (WWAN) operating, for example, under a cellular telephone network protocol, the respective wireless communications protocol typically includes provision for communication by the mobile wireless devices in the network via a wireless access point to a wired network infrastructure. These examples of wireless network protocols are not meant to be limiting, since it is common for wireless communications protocols to provide for communication between mobile wireless devices and a wired network infrastructure via wireless access points.

Each of these example networks is defined by its respective communications protocol to include the exchange of packets of data and control information between the wireless access point and the mobile wireless devices. Each of the communications protocols defines levels of networking functions and the services performed at each level for the wireless access points and the mobile wireless devices operating using the protocol. Typically, the networking functions include the transmission of packets by the access point having the purpose of announcing its presence to mobile wireless devices within range, either by initiating an inquiry or beacon packet or by responding with a response packet to a probe packet from a mobile device.

Existing wireless radio networks have used the fixed physical location of their wireless access points as landmarks for providing location information to mobile wireless devices within range. To accomplish this, either the packets transmitted by the access point include the geographic coordinates of the access point or the packets provide information sufficient to identify the access point and match it with a map of known access point locations. However, only fixed position wireless access points have been used in the past for providing location information to mobile wireless devices.

### SUMMARY

Example embodiments are disclosed of a method, apparatus, system, and computer program product for providing automated mode change for wireless devices during inactivity. The method includes the step of determining if a wireless device is stationary. This can be done, for example, by determining whether the device is plugged into a battery charger.

Another way of determining if a wireless device is stationary is by means of passive or active sensors. Example passive sensors can detect changes in the inertial frame of reference of the device, such as accelerometers and gyros. Example passive sensors can detect changes in the ambient barometric pressure, temperature, or light level. Example passive sensors can detect changes in the ambient electric field or magnetic field acting on the device. Example active sensors can transmit optical, infrared or acoustic pulses and detect changes in the echoed return pulse reflected from surrounding surfaces.

Another way of determining if a wireless device is stationary is by means of detecting a lack of user activity with the wireless device.

If the device is determined not to be in motion, then the method performs the step of changing an operating mode of the wireless device from mobile mode to access point mode.

In example embodiments, the method can then perform stationary location functions and services for the device's user, such as sounding an alarm or displaying a list of services advertised by other access points within range.

In example embodiments, the method can then perform the step of determining a current location for the wireless device with respect to a plurality of wireless access point devices. The method can determine the relative location of the device, for example, by analyzing received signals from each of the plurality of access points, to obtain a distance value from the wireless device to each of the plurality of access points. The method can then calculate a relative position of the wireless device with respect to the plurality of access points. The method can then access absolute positioning information, such as geographic coordinates, of each of the plurality of wireless access point devices and combine the relative position of the wireless device with the absolute positioning information of the plurality to obtain an absolute position of the wireless device, such as its own geographic coordinates.

The relative positioning method may perform a calculation, for example, based on signal strengths, wherein distances are related to the respective signal strengths. The relative positioning method may also perform triangulation based on the direction of the signal. The relative positioning method may also perform triangulation based on both direction and signal strength. Other relative positioning methods can include a proximity algorithm or other deterministic algorithms. The relative positioning method may be by pattern recognition of the received signals, matching the received pattern with stored patterns that are associated with known geographic locations.

In example embodiments, when the wireless device is in the access point mode, the method can enable the wireless device to provide stationary location services to other mobile wireless devices, such as providing the absolute position of the wireless device to other mobile wireless devices or by providing information on geographically local points of interest to other mobile wireless devices.

In example embodiments, if the method detects that that the wireless device is no longer stationary, then the method performs the step of changing the operating mode of the wireless device from access point mode to mobile mode.

### DESCRIPTION OF THE FIGURES

FIG. 1A illustrates an external view and a functional block diagram of an example embodiment of the mobile wireless device and a wireless access point network.

FIG. 1B illustrates the external view and the functional block diagram of FIG. 1A, where the mobile wireless device is currently stationary and has changed to the access point mode.

FIG. 1C illustrates the external view and the functional block diagram of FIG. 1A, where the mobile wireless device is currently in motion and has changed to the mobile mode.

FIG. 2A is a flow diagram of an example embodiment for automated mode change for wireless devices.

FIG. 2B is a flow diagram of an example embodiment for automated mode change for wireless devices of FIG. 2A and the provision of stationary location services for the mobile wireless device, itself, during inactivity.

FIG. 2C is a flow diagram of an example embodiment for automated mode change for wireless devices of FIG. 2B and the provision of stationary location services for other mobile devices, during inactivity of the mobile wireless device.

FIG. 3A is a functional block diagram of the random access memory (RAM) of the mobile wireless device when the mobile wireless device in the access point mode.

FIG. 3B is a functional block diagram of the random access memory (RAM) of the mobile wireless device when the mobile wireless device in the mobile mode.

FIG. 4 is a functional block diagram of the random access memory (RAM) of the mobile wireless device, with an access point pattern match buffer used in the “fingerprint” technique of comparing a pattern of signals currently received, with a map of multiple patterns of received signals previously stored in a database.

### DISCUSSION OF EXAMPLE EMBODIMENTS OF THE INVENTION

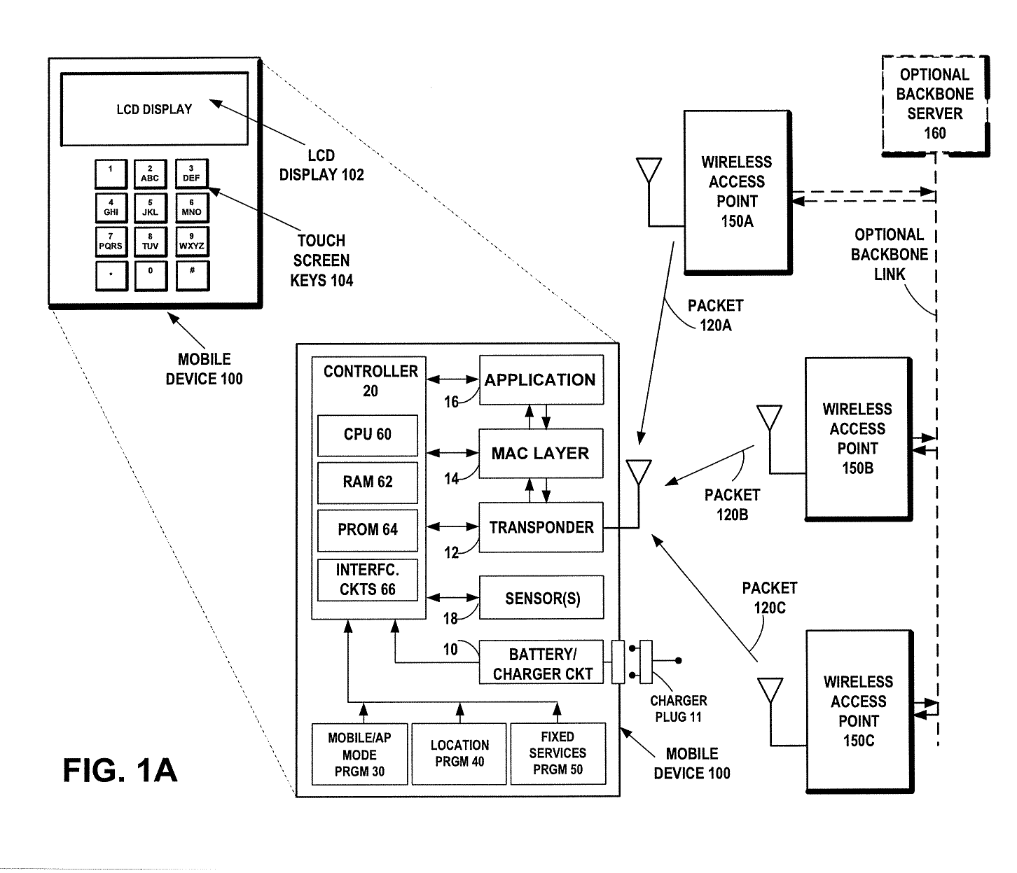

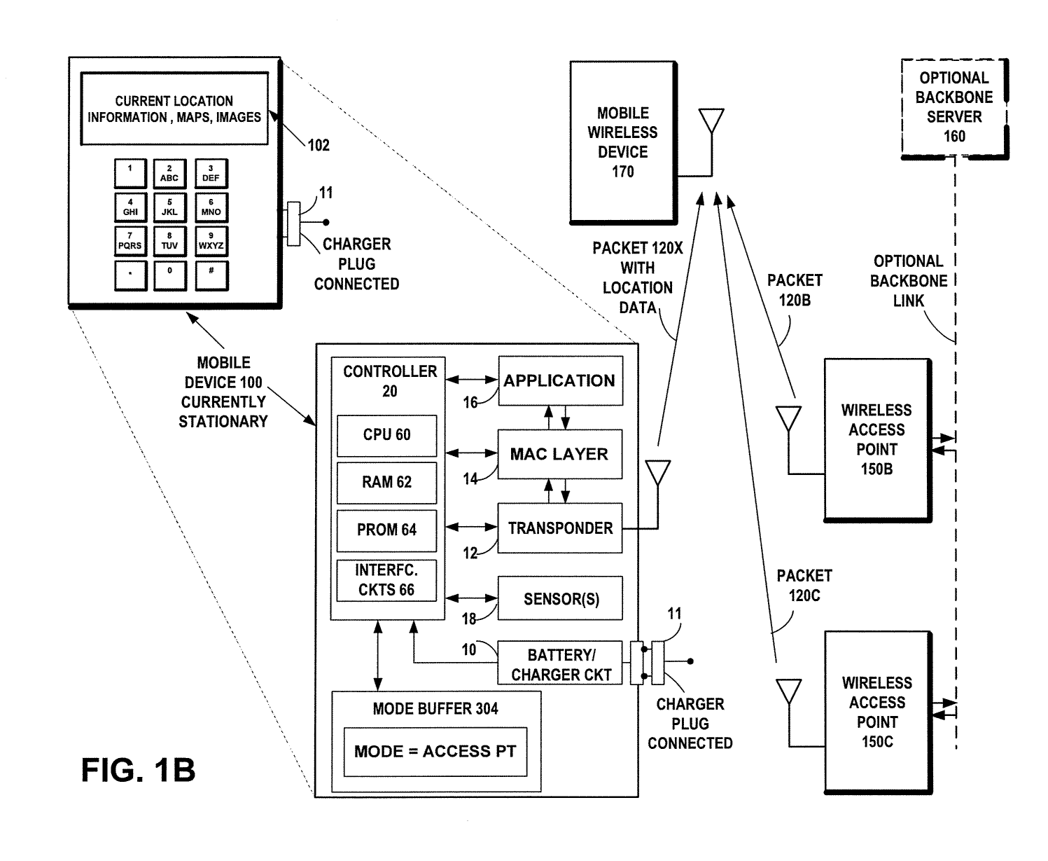

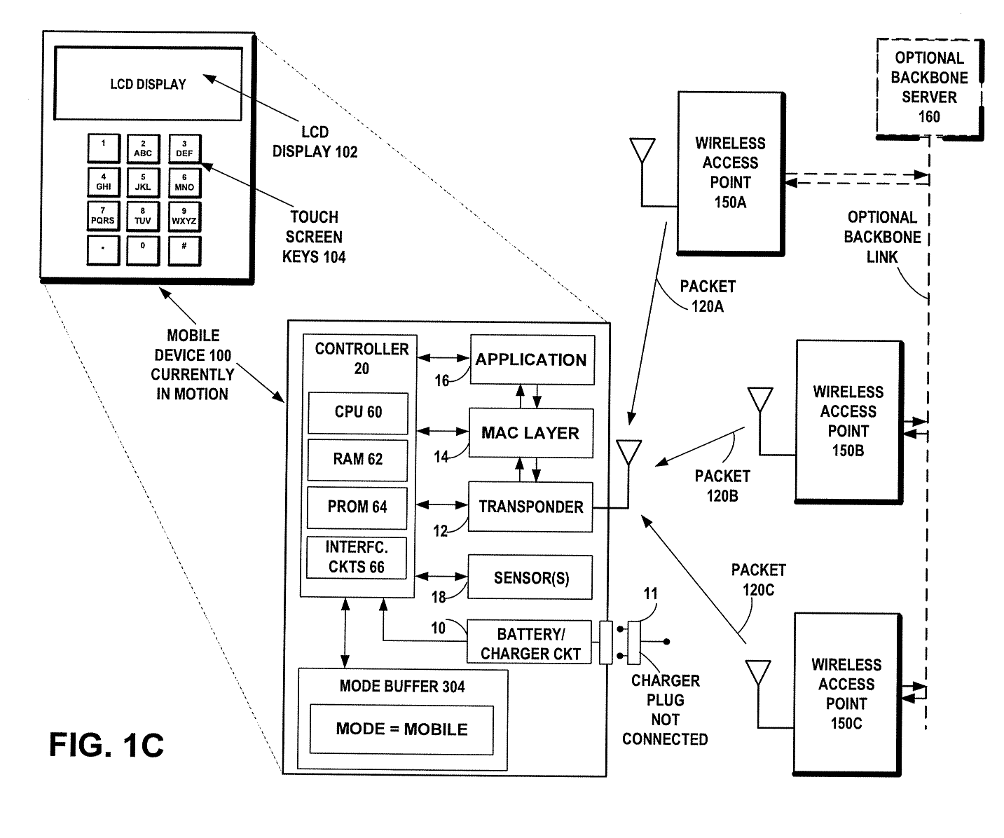

FIG. 1A illustrates an external view and a functional block diagram of an example embodiment of the mobile wireless device 100 and a network of wireless access points 150A, 150B, and 150C. The mobile wireless device 100 can be a mobile communications device, PDA, cell phone, laptop or palmtop computer, or the like. The mobile wireless device 100 can also be an integrated component of a vehicle, such as an automobile, bicycle, airplane or other mobile conveyance.

The mobile wireless device 100 and the wireless access points 150A, 150B, and 150C communicate in a wireless network that can be a wireless personal area network (WPAN) operating, for example, under the Bluetooth or IEEE 802.15 network protocol. The wireless network can be a wireless local area network (WLAN) operating, for example under the IEEE 802.11, Hiperlan, WiMedia Ultra Wide Band (UWB), WiMax, WiFi, or Digital Enhanced Cordless Telecommunications (DECT) network protocol. Or, the wireless network can be a wireless wide area network (WWAN) operating, for example, under a cellular telephone network protocol. The respective wireless network protocols include provision for communication by the mobile wireless device 100 in the network with the wireless access points 150A, 150B, and 150C. These examples of wireless network protocols for the device 100 are not meant to be limiting, since it is common for wireless communications protocols to provide for communication between mobile wireless devices and a wired network infrastructure via wireless access points.

The mobile device 100 includes a control module 20, which includes a central processing unit (CPU) 60, a random access memory (RAM) 62, a read only memory (ROM) or programmable read only memory (PROM) 64, and interface circuits 66 to interface with the key pad 104, and liquid crystal display (LCD) 102, and optional microphone, speakers, ear pieces, and camera or other imaging devices, etc. The RAM 62 and PROM 64 can be removable memory devices such as smart cards, Subscriber Identity Modules (SIMs), Wireless Application Protocol Identity Modules (WIMs), semiconductor memories such as a RAM, ROM, or PROM, flash memory devices, etc. The Medium Access Control (MAC) Layer 14 of the network protocol of the wireless device and/or application program 16 can be embodied as program logic stored in the RAM 62 and/or PROM 64 in the form of sequences of programmed instructions which can be executed in the CPU 60, carry out the functions of the disclosed embodiments. The program logic can be delivered to the writeable RAM, PROM, flash memory device, etc. 62 of the device 100 from a computer program product or article of manufacture in the form of computer-usable media such as resident memory devices, smart cards or other removable memory devices, or in the form of program logic transmitted over any transmitting medium which transmits such a program. Alternately, the MAC Layer 14 and/or application program 16 can be embodied as integrated circuit logic in the form of programmed logic arrays or custom designed application specific integrated circuits (ASIC). The transponder 12 in device 100 operates in accordance with the network protocol of the wireless device.

FIG. 1A further illustrates an optional backbone network for the access points 150A, 150B, and 150C. The access points 150A, 150B, and 150C may be mobile or fixed and each can know its own geographic location. If an access point is mobile, it can know its own geographic location, for example, by being in the “access point mode”, itself. Alternately, a mobile access point may know its own geographic location by means of a Global Positioning System (GPS) sensor. If the access points 150A, 150B, and 150C are fixed, they may be optionally connected over the backbone link of FIG. 1A to the backbone server 160. The optional server 160 can maintain a database of geographic coordinate location data, which represents the absolute position for each of the access points 150A, 150B, and 150C.

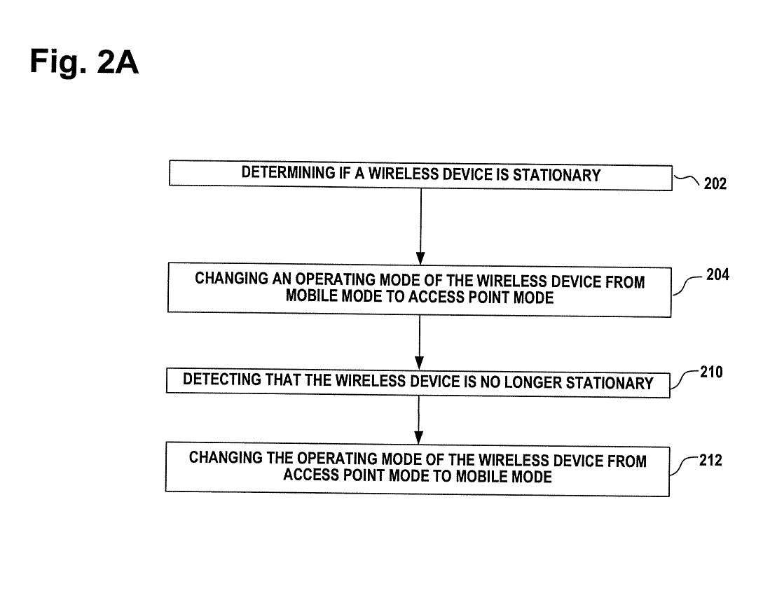

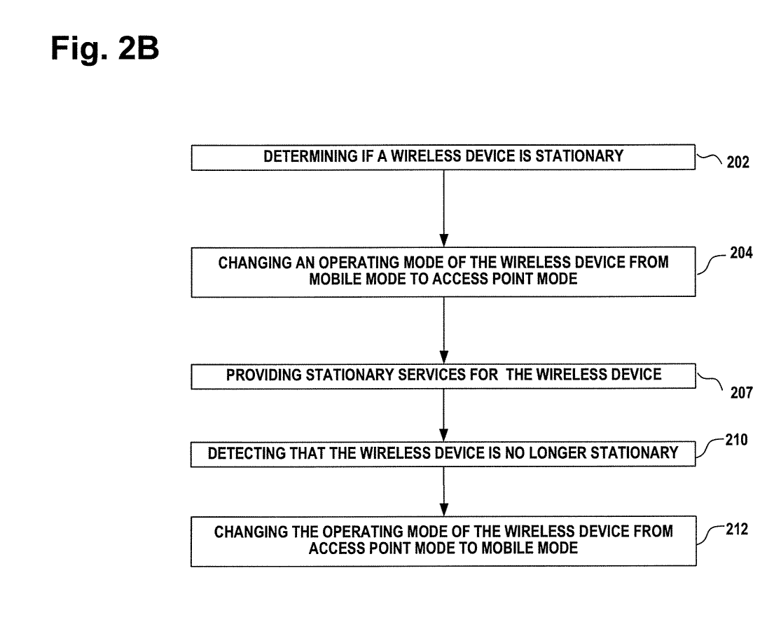

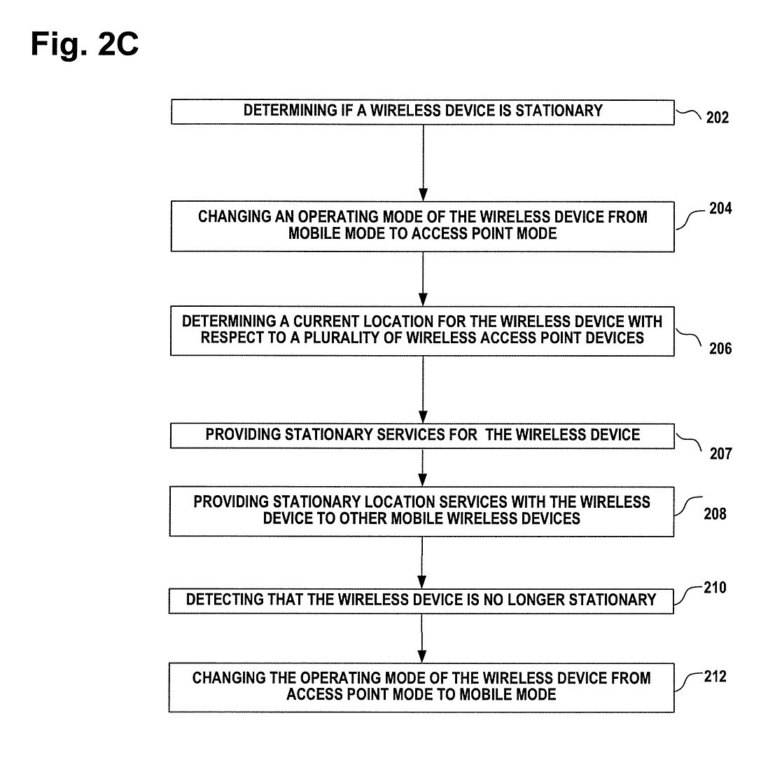

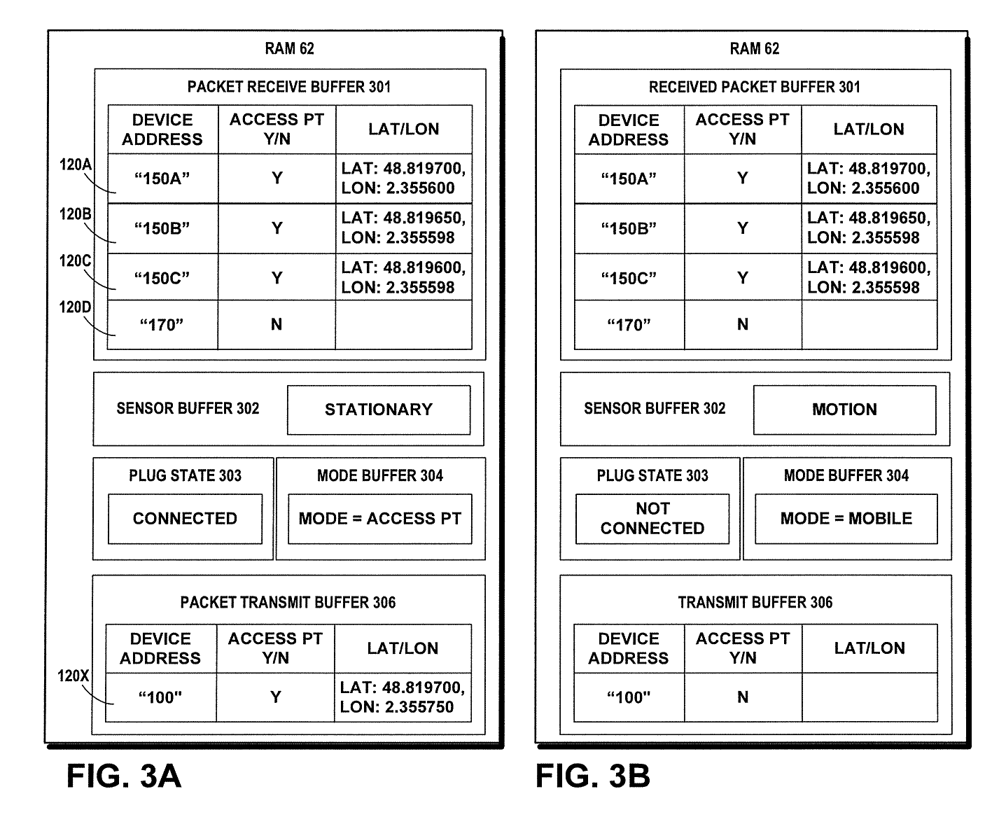

Embodiments provide automated mode change for the mobile wireless device 100 during inactivity of the mobile wireless device 100. The method includes the step 202 of the flow diagram of FIG. 2A, of determining if the wireless device 100 is stationary, for example by means of the circuit 10 detecting that the battery charger plug 11 is plugged into the wireless device 100. FIG. 1B illustrates the mobile wireless device 100 of FIG. 1A, where battery charger plug 11 is plugged into the wireless device 100, causing the circuit 10 to signal the connected condition to the controller 20. The plug state buffer 303 in the RAM 62 of FIG. 3A is set by the controller 20 to a value of “Connected” when the circuit 10 detects that the battery charger plug 11 is plugged into the wireless device 100. The controller 20 responds by changing the operating mode of the wireless device 100 from mobile mode to access point mode, using the mobile/AP mode program 30, and it stores the mode value “Access PT” in the mode buffer 304 of RAM 62, signifying that the device 100 is currently in the access point mode. The mobile/AP mode program 30 can be embodied as program logic stored in the RAM 62 and/or PROM 64 in the form of sequences of programmed instructions which can be executed in the CPU 60, carry out the functions of the disclosed embodiments. The step 204 of the flow diagram of FIG. 2A changes the operating mode of the wireless device 100 from mobile mode to access point mode.

FIG. 1C illustrates the mobile wireless device 100 of FIG. 1A, where battery charger plug 11 is disconnected from the wireless device 100, causing the circuit 10 to signal that disconnected condition to the controller 20. The plug state buffer 303 in the RAM 62 of FIG. 3B is set by the controller 20 to a value of “Not Connected” when the circuit 10 detects that the battery charger plug 11 is no longer plugged into the wireless device 100. The controller 20 responds by changing the operating mode of the wireless device 100 from access point mode to mobile mode, using the mobile/AP mode program 30, and it stores the mode value “Mobile” in the mode buffer 304 of the RAM 62, signifying that the device 100 is currently in the mobile mode. The step 210 of the flow diagram of FIG. 2A detects that the wireless device 100 is not plugged into the charger and thus the device 100 is no longer considered stationary and step 212 changes the operating mode of the wireless device 100 from access point mode to mobile mode.

Embodiments provide another way of determining if the wireless device 100 is stationary by means of passive or active sensors 18. Example passive sensors 18 can detect changes in the inertial frame of reference of the device 100, such as with accelerometers and gyros. Example passive sensors 18 can detect changes in the ambient barometric pressure with a barometer or altimeter, changes in the ambient temperature with a thermometer, or changes in the ambient light level with optical, ultraviolet, or infrared detectors. Example passive sensors 18 can detect changes in the ambient electric or magnetic field acting on the device 100 with a magnetometer or appropriate electromagnetic detectors. Example active sensors 18 can transmit acoustic, optical or infrared pulses and detect changes in the time-of-flight in the echoed return pulse reflected from surrounding surfaces. Example active sensors 18 can transmit optical or infrared pulses and detect a Doppler-shift in the wavelength of the echoed return pulse reflected from surrounding surfaces.

The sensors 18 can detect that there are no such changes in position as shown in FIG. 1B, and signal the controller 20 that the device 100 is stationary. The sensor buffer 302 in the RAM 62 of FIG. 3A is set by the controller 20 to a value of “Stationary” when sensors 18 detect that there are no changes in position. The controller 20 responds by changing the operating mode of the wireless device 100 from mobile mode to access point mode, using the mobile/AP mode program 30, and it stores the mode value “Access PT” in the mode buffer 304, signifying that the device 100 is currently in the access point mode. The step 204 of the flow diagram of FIG. 2A changes the operating mode of the wireless device 100 from mobile mode to access point mode.

When the sensors 18 detect that such changes in position of device 100 have resumed as shown in FIG. 1C, they signal the controller 20 that the device 100 is in motion. The sensor buffer 302 in the RAM 62 of FIG. 3B is set by the controller 20 to a value of “Motion” when sensors 18 detect that there is a resumption in changes in position. The controller 20 responds by changing the operating mode of the wireless device 100 from access point mode to mobile mode, using the mobile/AP mode program 30, and it stores the mode value “Mobile” in the mode buffer 304, signifying that the device 100 is currently in the mobile mode. The step 210 of the flow diagram of FIG. 2A detects that the wireless device 100 is no longer considered stationary and step 212 changes the operating mode of the wireless device 100 from access point mode to mobile mode.

Embodiments provide another way of determining if the wireless device 100 is stationary by detecting a lack of user activity, as indicated by the interaction of the keys 104 with the interface circuits 66. If the interface circuits 66 detect that there is user activity, interface circuits 66 signal the controller 20 that the device 100 is stationary. The controller 20 responds by changing the operating mode of the wireless device 100 from mobile mode to access point mode, using the mobile/AP mode program 30, and it stores the mode value “Access PT” in the mode buffer 304 of RAM 62, signifying that the device 100 is currently in the access point mode. The step 204 of the flow diagram of FIG. 2A changes the operating mode of the wireless device 100 from mobile mode to access point mode.

If the interface circuits 66 detect that there is no user activity, interface circuits 66 signal the controller 20 that the device 100 may be in motion. The controller 20 responds by changing the operating mode of the wireless device 100 from access point mode to mobile mode, using the mobile/AP mode program 30, and it stores the mode value “Mobile” in the mode buffer 304 of RAM 62, signifying that the device 100 is currently in the mobile mode. The step 210 of the flow diagram of FIG. 2A detects that the wireless device 100 is no longer considered stationary and step 212 changes the operating mode of the wireless device 100 from access point mode to mobile mode.

In example embodiments, the method can then perform stationary location functions and services for the user of device 100, such as sounding an alarm or displaying a list of services advertised by other access points within range. In another example, if the wireless device 100 is an integrated component of a vehicle, such as an automobile or bicycle, then when the device 100 is stationary, the “access point mode” can trigger the deployment other devices, for example highway safety equipment, such as retro-reflectors. FIG. 2B is an example flow diagram of an example embodiment for automated mode change for wireless device 100 and provision of stationary location services for the mobile wireless device 100, itself, during inactivity. Step 207 provides stationary services for the user of the wireless device 100 when in the access point mode.

FIG. 2C is an example flow diagram of an example embodiment for automated mode change for wireless device 100 and provision of stationary location services for other mobile devices, during inactivity of the mobile wireless device 100. Step 206 of FIG. 2C determines the current location for the wireless device 100 with respect to the plurality of wireless access points 150A, 150B, and 150C.

In example embodiments, the method can perform the step of determining the current location for the wireless device 100 with respect to the plurality of wireless access points 150A, 150B, and 150C, for example, by analyzing received signals from each of the plurality of access points, to obtain a relative distance value of the wireless device 100 from each of the plurality of access points 150A, 150B, and 150C. The location program 40 determines a current relative position of the device 100 with respect to the plurality of wireless access point devices 150A, 150B, and 150C. The location program 40 can be embodied as program logic stored in the RAM 62 and/or PROM 64 in the form of sequences of programmed instructions which can be executed in the CPU 60, carry out the functions of the disclosed embodiments.

In embodiments, the location program 40 can then access absolute positioning information, such as the geographic coordinates, of each of the plurality of wireless access point devices 150A, 150B, and 150C. The geographic coordinates of each of the plurality of wireless access point devices 150A, 150B, and 150C can be stored in a database in the mobile device 100 or can be provided in the signals sent by the wireless access points 150A, 150B, and 150C to the mobile device 100. For example, FIG. 1A shows the wireless access point 150A sending packet 120A to the mobile wireless device 100. FIG. 3A shows packet 120A stored in the packet receive buffer 301 of the RAM 62, with a field designating the device address “150A”, a field designating that the sending device 150A is an access point “Y”, and a field providing the latitude and longitude of the sending device 150A. FIG. 3A shows packet 120B sent from access point 150B and packet 120C sent from access point 150C with similar fields and data. Note that packet 120D in FIG. 3A is from device 170, which is not designated as an access point and, accordingly, does not contain location information. The location program 40 in the mobile device 100 can combine the latitude and longitude values provided in the respective packets 120A, 120B, and 120C of the access points 150A, 150B, and 150C with the relative positions calculated for the device 100 with respect to the respective access points 150A, 150B, and 150C, to compute the absolute location of the device 100, expressed, for example, in its latitude and longitude.

The geographic coordinates of each of the plurality of wireless access point devices 150A, 150B, and 150C can alternately be provided to the device 100 in removable memory devices such as smart cards, SIMs, WIMs, or semiconductor memories such as a RAM, ROM, or PROM.

An example relative positioning method may determine the relative position of the device 100 based on received signal strengths of signals received by device 100 from each of the wireless access point devices 150A, 150B, and 150C, wherein distances are related to the radio frequency power loss between each respective access point and the device 100. The location program 40 can execute a triangulation algorithm to estimate the location of the device 100 to be at the intersection of circles with their centers at each respective wireless access point device 150A, 150B, and 150C, the radius of the respective circle being determined by the respective received signal strength.

Another example relative positioning method may determine the relative position of the device 100 based on the time of arrival of a reference signal from the device 100 to each of the wireless access point devices 150A, 150B, and 150C. The difference in the time of arrival of the same reference signal at the three wireless access point devices 150A, 150B, and 150C can be used to calculate the relative position of the device 100 with respect to the access point devices. The location program 40 can execute a triangulation algorithm to estimate the location of the device 100 to be at the intersection of circles with their centers at each respective wireless access point device 150A, 150B, and 150C, the radius of the respective circle being determined by the respective times of arrival of the reference signal.

Another example relative positioning method may determine the relative position of the device 100 based on the angle of arrival of a reference signal from the device 100 to each of the wireless access point devices 150A, 150B, and 150C. The difference in the angle of arrival of the reference signal at the three wireless access point devices 150A, 150B, and 150C can be used to calculate the relative position of the device 100 with respect to the access point devices. The location program 40 can execute a triangulation algorithm to estimate the location of the device 100 to be at the intersection of lines of position with respect to each respective wireless access point device 150A, 150B, and 150C, the line of position being determined by the respective angle of receipt of the reference signal. The positioning method may also perform triangulation based on both angle of arrival and signal strength techniques.

Another example relative positioning method may determine the relative position of the device 100 based on comparing the pattern of signals currently received by device 100 with a map of multiple patterns of received signals previously stored in a database, a technique known as “fingerprinting”. The location program 40 can match the currently received pattern of signals from wireless access point devices 150A, 150B, and 150C with stored patterns in the database, which can be used to calculate the relative position of the device 100 with respect to the access point devices. The stored patterns in the database can also be provided to the device 100 in removable memory devices such as smart cards, SIMs, WIMs, or semiconductor memories such as a RAM, ROM, or PROM.

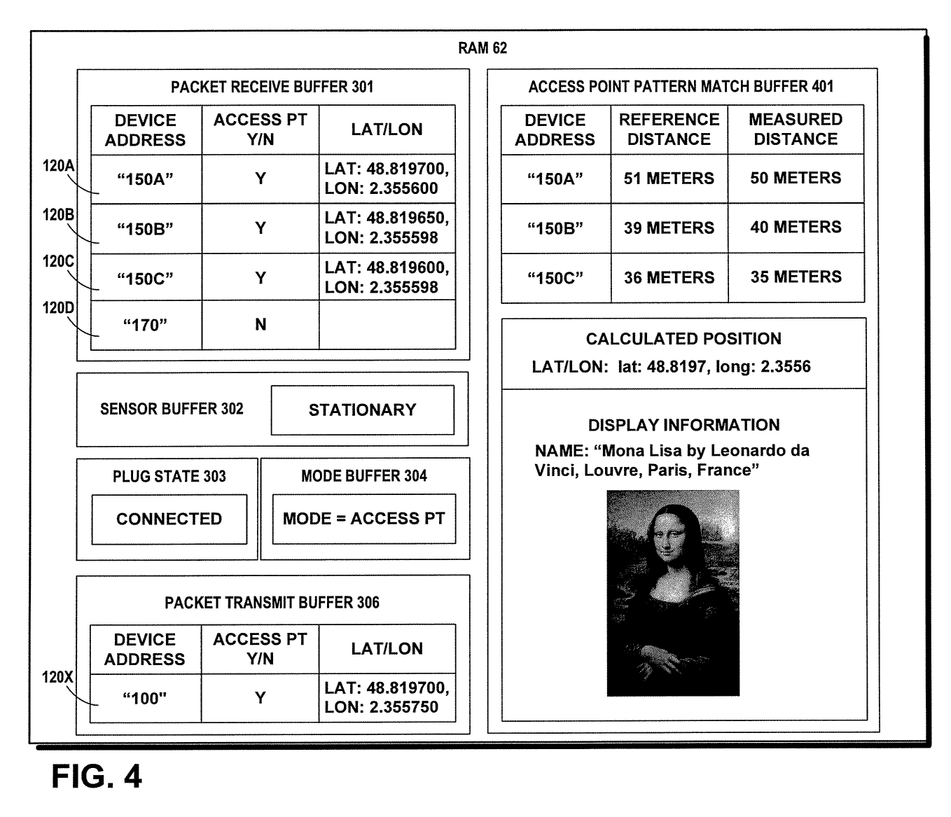

FIG. 4 shows an example of an access point pattern match buffer 401 in the RAM 62, which can be used in the “fingerprint” technique of comparing the pattern of signals currently received by device 100 with a map of multiple patterns of received signals previously stored in a database. An example pattern is stored in the buffer 401 in the form of the respective sending device address value of packets received by the device 100 and the corresponding reference, relative distance to the respective sending devices. The currently measured relative distance to the respective sending devices is computed using one of the above relative positioning techniques for received signal strength, time of arrival, or angle of arrival of signals. Then the reference and measured distances are compared, for example, by using a least squares computation for the differences between the corresponding reference and measured values. There will be many patterns of received signals previously stored in the buffer 401. If the least squares result for a particular stored pattern is less than a predetermined threshold value, then the device 100 is estimated to be located near the corresponding calculated position value stored in the buffer 401 in association with the particular stored pattern. In the example of FIG. 4, the user is exploring a museum, such as Louvre, Paris, France. The museum has a network of wireless access point devices 150A, 150B, and 150C arranged at various points of interest. The user has stopped near a point of interest, and the sensors in the user's device 100 determine that the device is stationary, and thus the device transitions from the mobile mode to the access point mode and proceeds to determine its current position by the “fingerprint” technique. It calculates its location as the calculated position shown in the buffer 401 of FIG. 4, and accesses the corresponding text and image data stored in buffer 401 in association with the calculated position. The corresponding text and image data stored in buffer 401 are then displayed to the user on the display 102 of the device 100. The device 100, in the access point mode, may also transmit its calculated location to other mobile wireless devices in range.

The wireless access point devices 150A, 150B, and 150C of FIG. 1A may not connected to an infrastructure network, and yet they can know their geographic location. If an access point is not connected to an infrastructure network, the unconnected access point it may know its geographic location from using, for example, its own copy of the location program 40. The location program 40 determines the current location of the unconnected access point with respect to the plurality of other wireless access point devices, for example, by analyzing received signals from each of the plurality of other wireless access point devices, to obtain a relative distance value from the unconnected access point to each of the plurality of other wireless access point devices and then calculating a relative position of the unconnected access point with respect to the plurality of other access point devices. The positioning method may be by “triangulation” based on signal strengths, wherein distances are proportional to the signal strength. The positioning method may also be by triangulation based on direction of the signal or triangulation based on direction and signal strength. Other positioning methods can include a proximity algorithm or other deterministic algorithms.

After determining the relative position of the wireless device 100, the location program 40 then accesses from each access point the absolute positioning information, such as geographic coordinates, of each of the plurality of wireless access point devices 150A, 150B, and 150C and combines the calculated relative position of the wireless device 100 with the absolute positioning information of the plurality 150A, 150B, and 150C to obtain an absolute position of the wireless device 100, such as its own geographic coordinates.

In Step 208 of the example flow diagram of FIG. 2C, when the device 100 is in the access point mode, it can provide stationary location services to other mobile wireless devices, such as mobile device 170 of FIG. 1B. When the device 100 is in the access point mode shown in FIG. 1B, it can send packet 120X containing its location data to mobile device 170. FIG. 3A shows packet 120X stored in the packet transmit buffer 306 of the RAM 62, with a field designating the device address “100”, a field designating that the device 100 is an access point “Y”, and a field providing the latitude and longitude of the device 100. The method can provide stationary location services with the wireless device 100 to other mobile wireless devices 170, using the fixed services program 50. The fixed services program 50 can provide the absolute position of the wireless device 100 to other mobile wireless devices or it can provide information on geographically local points of interest to other mobile wireless devices. The fixed services program 50 can be embodied as program logic stored in the RAM 62 and/or PROM 64 in the form of sequences of programmed instructions which can be executed in the CPU 60, carry out the functions of the disclosed embodiments.

Alternately, when the device 100 is in the mobile mode shown in FIG. 1C, its packet 120X no longer contains its location data. FIG. 3B shows packet 120X stored in the packet transmit buffer 306 of the RAM 62, with a field designating the device address “100”, a field designating that the device 100 is not an access point “N”, and no field containing position data of the device 100.

In Step 210 of the example flow diagram of FIG. 2C, if the method detects that that the wireless device 100 is no longer stationary, then the method performs the Step 212 of changing the operating mode of the wireless device 100 from access point mode to mobile mode.

The resulting embodiments enable using the inactive time when a mobile device is not moving to assist others by changing its mode to a new state or condition of performing as if it were an access point.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as a RAM, ROM, or PROM, etc. Transmitting mediums include, but are not limited to, transmissions via wireless communication networks, satellite communication, and other mobile network systems/communication links.

Although specific example embodiments have been disclosed, a person skilled in the art will understand that changes can be made to the specific example embodiments without departing from the spirit and scope of the embodiments.

What is claimed is:

1. A method, comprising:
determining that a wireless device is stationary; and
changing an operating mode of the wireless device from mobile mode to access point mode in response to said determining.

2. The method of claim 1, further comprising:
detecting that the wireless device is no longer stationary; and
changing the operating mode of the wireless device from access point mode to mobile mode.

3. The method of claim 1, further comprising:
determining a current location for the wireless device with respect to a plurality of wireless access point devices; and
providing stationary location services with the wireless device.

4. The method of claim 1, further comprising:
determining a current location for the wireless device with respect to a plurality of wireless access point devices; and
providing stationary location services with the wireless device to other mobile wireless devices.

5. The method of claim 1, further comprising:
determining if the wireless device is stationary by means of being plugged into a battery charger.

6. The method of claim 1, further comprising:
determining if the wireless device is stationary by means of one or more sensors.

7. The method of claim 6, wherein said sensors are either passive or active.

8. The method of claim 6, wherein said sensors are passive sensors drawn from the group consisting of accelerometers, gyros, barometers, altimeters, thermometers, optical detectors, ultraviolet detectors, infrared detectors, magnetometers, and electromagnetic detectors.

9. The method of claim 6, wherein said sensors are active sensors drawn from the group consisting of acoustic, optical, and infrared devices that transmit pulses and detect changes in echoed return pulses reflected from surrounding surfaces.

10. The method of claim 1, further comprising:
determining if the wireless device is stationary by means of a lack of user activity.

11. The method of claim 3, further comprising:
determining a relative location with respect to said plurality of wireless access point devices by analyzing received signals from each of said plurality; and
calculating a relative position of said wireless device with respect to said plurality of wireless access point devices.

12. The method of claim 11, wherein said received signals are analyzed by received signal strengths.

13. The method of claim 11, wherein said received signals are analyzed by time of arrival of a reference signal.

14. The method of claim 11, wherein said received signals are analyzed by angle of arrival of a reference signal.

15. The method of claim 11, wherein said received signals are analyzed by comparing a pattern of currently received signals with reference patterns of received signals.

16. The method of claim 11, further comprising:
obtaining absolute positioning information of each of said plurality of wireless access point devices; and
combining said relative position of said wireless device with said absolute positioning information of said plurality to obtain an absolute position of said wireless device.

17. The method of claim 16, further comprising:
providing stationary location services with the wireless device, by providing said absolute position of said wireless device to other mobile wireless devices.

18. The method of claim 16, further comprising:
providing stationary location services with the wireless device, by providing information on geographically local points of interest to other mobile wireless devices.

19. The method of claim 1, further comprising:
determining if the wireless device has resumed motion by means of sensors.

20. The method of claim 1, further comprising:
determining if the wireless device has resumed motion by means of becoming unplugged from a battery charger.

21. The method of claim 1, further comprising:
said wireless device using a wireless protocol drawn from the group consisting of Bluetooth, IEEE 802.15, IEEE 802.11, Hiperlan, WiMedia Ultra Wide Band (UWB), WiMax, WiFi, Digital Enhanced Cordless Telecommunications (DECT), and a cellular telephone network protocol.

22. An apparatus, comprising:
a detector configured to determine that a wireless device is stationary; and
a processor configured to change an operating mode of the wireless device from mobile mode to access point mode, in response to said detector.

23. The apparatus of claim 22, further comprising:
said detector configured to detect that the wireless device is no longer stationary; and
said processor configured to change the operating mode of the wireless device from access point mode to mobile mode.

24. The apparatus of claim 22, further comprising:
a transceiver configured to determine a current location for the wireless device with respect to a plurality of wireless access point devices, in response to said processor; and
said transceiver configured to provide stationary location services with the wireless device.

25. The apparatus of claim 22, further comprising:
a transceiver configured to determine a current location for the wireless device with respect to a plurality of wireless access point devices, in response to said processor; and
said transceiver configured to provide stationary location services with the wireless device to other mobile wireless devices.

26. The apparatus of claim 22, further comprising:
said detector configured to determine if the wireless device is stationary by means of being plugged into a battery charger.

27. The apparatus of claim 22, further comprising:
said detector configured to determine if the wireless device is stationary by means of one or more sensors.

28. The apparatus of claim 27, wherein said sensors are either passive or active.

29. The apparatus of claim 27, wherein said sensors are passive sensors drawn from the group consisting of accelerometers, gyros, barometers, altimeters, thermometers, optical detectors, ultraviolet detectors, infrared detectors, magnetometers, and electromagnetic detectors.

30. The apparatus of claim 27, wherein said sensors are active sensors drawn from the group consisting of acoustic, optical, and infrared devices that transmit pulses and detect changes in echoed return pulses reflected from surrounding surfaces.

31. The apparatus of claim 22, further comprising:
said detector configured to determine if the wireless device is stationary by means of a lack of user activity.

32. An apparatus, comprising:
means for determining that a wireless device is stationary; and
means for changing an operating mode of the wireless device from mobile mode to access point mode in response.

33. The apparatus of claim 32, further comprising:
means for detecting that the wireless device is no longer stationary; and
means for changing the operating mode of the wireless device from access point mode to mobile mode.

34. The apparatus of claim 32, further comprising:
means for determining a current location for the wireless device with respect to a plurality of wireless access point devices; and
means for providing stationary location services with the wireless device.

35. The apparatus of claim 32, further comprising:
means for determining a current location for the wireless device with respect to a plurality of wireless access point devices; and
means for providing stationary location services with the wireless device to other mobile wireless devices.

36. A computer program product, comprising:
a computer readable medium containing program code executable by a computer;
program code in said computer readable medium for determining that a wireless device is stationary; and
program code in said computer readable medium for changing an operating mode of the wireless device from mobile mode to access point mode in response to said determining.

37. The computer program product of claim 36, further comprising:
program code in said computer readable medium for detecting that the wireless device is no longer stationary; and
program code in said computer readable medium for changing the operating mode of the wireless device from access point mode to mobile mode.

38. The computer program product of claim 36, further comprising:
program code in said computer readable medium for determining a current location for the wireless device with respect to a plurality of wireless access point devices;
program code in said computer readable medium for providing stationary location services with the wireless device.

39. The computer program product of claim 36, further comprising:
program code in said computer readable medium for determining a current location for the wireless device with respect to a plurality of wireless access point devices;
program code in said computer readable medium for providing stationary location services with the wireless device to other mobile wireless devices.
